(19) United States
(12) Patent Application Publication
(10) Pub. No.: US 2024/0165697 A1
(43) Pub. Date: May 23, 2024

(54) DISC FOR A DISC BRAKE FOR MOTORCYCLES

(71) Applicant: Giampietro ABENI, Lonato del Garda (Brescia) (IT)

(72) Inventor: Giampietro ABENI, Lonato del Garda (Brescia) (IT)

(21) Appl. No.: 18/283,320

(22) PCT Filed: Mar. 24, 2021
(86) PCT No.: PCT/IB2021/052429

§ 371 Date: Sep. 21, 2023

(51) Int. Cl. B22D 13/02; B22D 30/00; B22D 31/00; F16D 65/12

(52) U.S. Cl. CPC B22D 13/02; B22D 30/00; B22D 31/002; F16D 65/125; F16D 2200/0013; F16D 2250/0007; F16D 2250/003; F16D 2250/0038

(57) ABSTRACT

A process for making a braking band for a disc of a disc brake for motorcycles provides performing a casting by centrifugal casting of a predefined quantity of cast iron, obtaining a tubular semi-finished product, transversely cutting the tubular semi-finished product, obtaining a plurality of semi-finished bands having a thickness substantially equal to a thickness of the braking band, and cooling the semi-finished bands, obtaining semi-finished bands in spheroidal cast iron or mainly in spheroidal cast iron. The semi-finished bands are subjected to a chip removal process to obtain finished braking bands.

The present invention belongs to the field of processes for making discs for a disc brake for motorcycles, and in particular for racing motorcycles. Moreover, the present invention relates to a disc for a disc brake obtained according to the aforesaid process.

It is common in the field of motor vehicles for a disc for a disc brake to be made of lamellar cast iron. Lamellar cast iron is highly advantageous for such an application because, exploiting the excellent castability properties of cast iron, allows a production by means of chilled casting, which is particularly adapted to mass production.

Several attempts have been made in the field of motorcycles to implement disc brake discs in lamellar cast iron obtained by chilled casting in order to obtain the same advantages as those in the field of motor vehicles.

This was not the case. Contrarily, lamellar cast iron discs for motorcycles have highlighted several drawbacks, sometimes even exploding during the certification tests.

This forced manufacturing companies to implement steel discs for motorcycles, with subsequent production drawbacks. It indeed is well known that steel does not have increased castability.

It is the object of the present invention to make a process for obtaining a disc for a disc brake for motorcycles which overcomes the drawbacks mentioned with reference to the prior art, and meets the needs of the sector, especially in case of racing motorcycles.

Such an object is achieved by the process according to claim 1. The dependent claims identify further advantageous embodiments of the invention.

The features and advantages of the process according to the present invention will become apparent from the following description, given by way of non-limiting example.

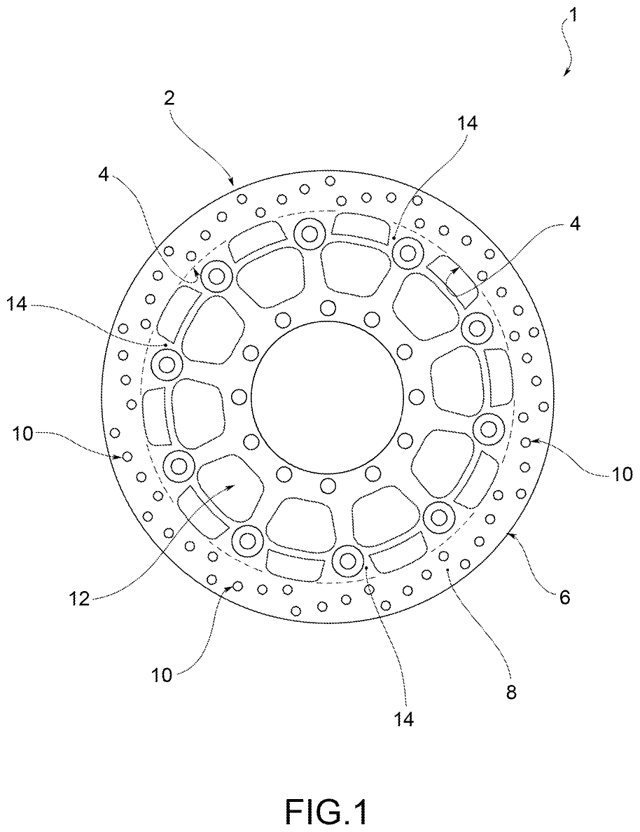

FIG. 1 depicts a disc for a disc brake made according to the process of the present invention.

According to the invention, a disc 1 for a disc brake comprises a braking band 2 having the shape of a circular crown with a predefined thickness, having a main axis of rotation.

The braking band 2 extends between an inner circumferential edge 4 and an outer circumferential edge 6; a braking surface 8 intended to come into contact with the friction material of the disc brake pad extends on each side, between the inner edge 4 and the outer edge 6. The braking band 2 further comprises, at the outer edge 6, a cylindrical side surface, which width is the thickness of the braking band.

According to one embodiment variant, the braking band 2 comprises a plurality of axial holes 10 which are open on the braking surface 8, preferably arranged according to a predefined pattern, open on each side, i.e., passing through the thickness of the band, or blind holes.

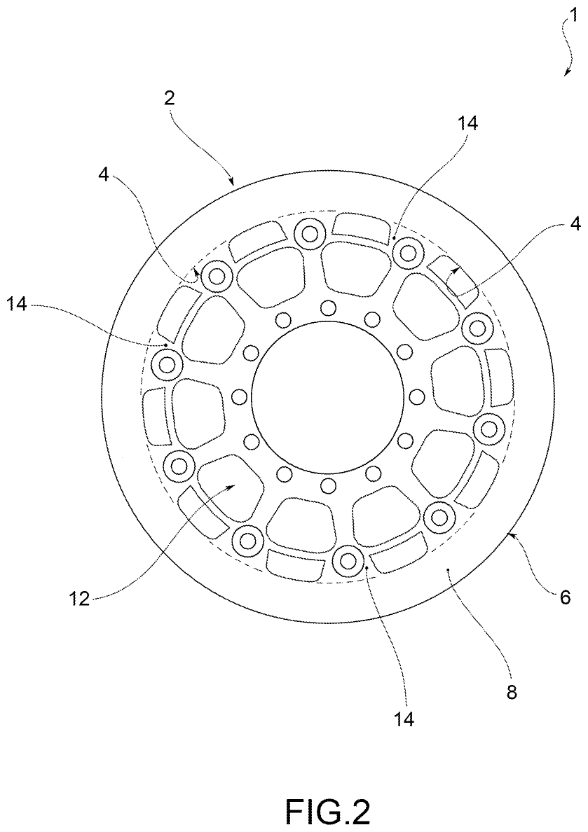

According to a further embodiment variant, the braking band 2 comprises a braking surface 8 free of axial through holes 10, as shown by way of example in FIG. 2.

The disc brake 1 further comprises a bell 12, also called anchoring flange, which is coaxial to the braking band 2, suitable to be connected to the wheel hub and the braking band 2. In other words, the braking band 2 and bell 12 are two separate components.

In particular, the braking band 2 provides, at the inner edge, connection means for connecting with bell 12.

For example, said connection means comprise a plurality of tabs 14 which radially protrude internally from the inner edge 4, for connecting with bell 12.

The braking band 2 further comprises a plurality of radial holes 15, which are open on the side surface and radially passing from the outer edge 6 to the inner edge 4, i.e., in the direction incident to the main axis of rotation.

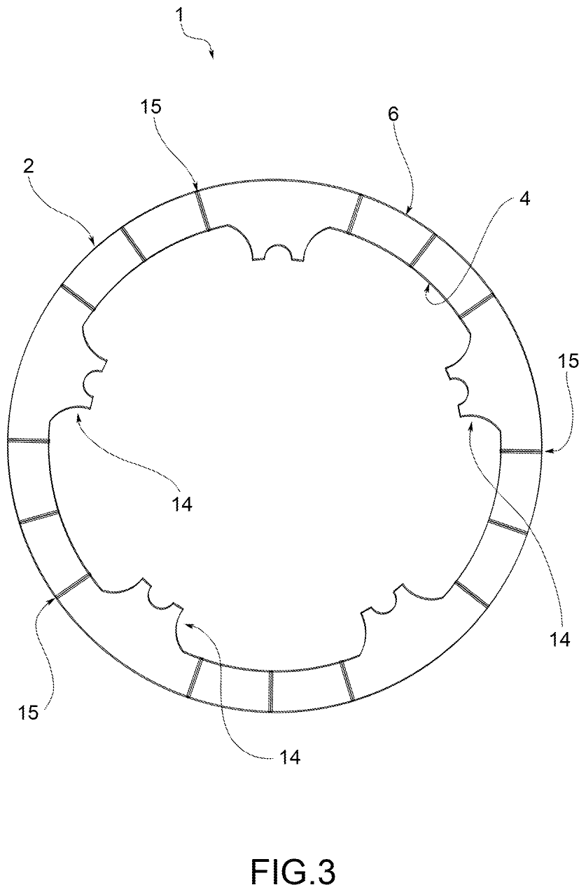

According to an embodiment, the radial holes 15 are located, angularly equally spaced, along the circumference or in groups alternated by a tab 14, as shown in FIG. 3.

According to the invention, the disc brake comprises at least one friction pad, each comprising a base surface directed towards disc 1, and a layer of friction material which at least partly covers the base surface and is intended to come into contact with the braking band 2 to brake the rotation of disc 1.

Preferably, the friction material comprises organic fibers, such as e.g., natural rubber fibers and/or carbon fibers.

According to the invention, the process of making the braking band provides a first step in which a predefined quantity of cast iron is cast by centrifugal casting.

During the casting, the molten material is introduced into a permanent tubular mold, called shell, kept in rotation. The centrifugal force facilitates filling the mold and allows a tubular semi-finished product, i.e., centrally hollow, to be obtained.

The cast iron used is preferably hypo-eutectic (carbon <4.3%), with a carbon concentration preferably between 3.5 and 4%.

The tubular semi-finished product is cooled, preferably in air; after sufficient cooling to give the semi-finished product consistency, the shell is opened.

The tubular semi-finished product is subjected to a first heat treatment, during which it is tempered by heating in a kiln at a temperature ranging from 400-500° C. for a time period between 1 and 4 hours.

After the tempering and the successive cooling, for example slowly in air, the tubular semi-finished product is subjected to cutting, which generally is performed on a numerical control lathe, in the transverse direction, i.e., perpendicularly to the tube axis, so as to obtain a plurality of semi-finished bands, each consisting of a tubular body having reduced thickness, substantially equal to the thickness desired for the braking band.

Each semi-finished band is then subjected to a second heat treatment, in which it is heated in a kiln up to a temperature between 700-800° C.; the semi-finished band preferably is subjected to progressive heating up to the desired temperature, is kept at such temperature for a predefined time period, and then is cooled, for example slowly in air.

Generally, from 12 to 24 hours transpire from the beginning of the heating to the end of the cooling.

Due to the composition of the cast iron, of the heat treatments to which first the semi-finished product and then the semi-finished bands are subjected, with reference in particular to the duration and the temperatures reached, the heat-treated semi-finished band consists of spheroidal cast iron or mainly spheroidal cast iron, i.e., with minimum 50% concentration of spheroidal cast iron.

The heat-treated semi-finished band finally is subjected to mechanical processing to remove chips, for example for making connection means (and tabs, in particular), holes and possibly for finishing the braking surfaces.

Moreover, the mechanical processing preferably comprises making radial holes 15 in the braking band 2 by drilling.

Each braking band thus finished is finally connected to the respective bell.

Innovatively, the process according to the present invention meets the needs of the sector and overcomes the drawbacks mentioned.

Firstly, the braking band according to the invention does not undergo a propagation of the cracks, thus avoiding the explosion of the disc during use and during certification or performance tests.

Moreover, during the use of the disc brake, the braking band according to the invention exhibits a more effective braking action than the one of a disc having a steel braking band of equal size.

The braking band according to the invention indeed highlights a uniform distribution of heat, which prevents the band from twisting during use. It is instead known how steel bands have a very hot braking surface, while the temperature suddenly decreases towards the inside of the thickness.

Moreover, the band according to the invention maintains an optimal braking action even at the increased temperatures reached during intense or repeated braking, while steel bands highlight a sudden decrease of the braking action at a high temperature due to a kind of “rejection” of the pads.

Contrarily, the band according to the invention shows an improved braking action when hot.

Advantageously, there is no need to make through holes axially in order to cool the braking surface, in any case obtaining a highly controlled and regular wear of the pads.

Advantageously, the presence of the radial holes allows homogeneous cooling to be obtained even in radial direction.

Moreover, the braking surface of the bands according to the invention is porous and therefore ensures increased friction with the disc brake pads, to the benefit of the braking action and obtaining a continuous surface cleaning action on the pads.

According to a further advantageous aspect, the spheroidal cast iron has a specific weight (7.2 kg/dm3) which is less than the one of steel (7.85 kg/dm3); this allows the overall weight of the motorcycle to be reduced, which is an essential factor especially in races, and the weight of the rotating masses to be reduced.

Advantageously, the type of spheroidal cast iron reduces the phenomenon of sudden heat exchanges with the air, thus obviating the problems related to the thermal gradient between the opposite braking bands of the disc.

Advantageously, the thickness of the disc may be reduced without running into twisting phenomena.

Advantageously, the synergistic presence of the spheroidal cast iron structure of the braking band and the pads comprising organic materials allows the performance of the disc brake to be improved.

Indeed, for disc brakes with steel discs, the temperatures achieved by the disc require the use of pads comprising sintered metals, especially in the racing field. However, such sintered pads have poor braking features at low temperatures, i.e., prior to the expansion, and act aggressively on the disc, rapidly wearing it out.

The pads comprising organic materials instead avoid an excessive wear of the disc and allow optimal braking performance to be obtained also at low temperatures, also in the absence of interruptions in the braking surface.

Therefore, the drawbacks related to the breaking-in and the heating of the pads advantageously are overcome, thus obtaining a vigorous braking action also under the initial conditions of the motorcycle.

Advantageously, the braking band and the bell are made of different material, for example the bell is in an aluminum alloy and obtained from solid, further increasing the safety for the driver.

It is apparent that, in order to meet contingent needs, those skilled in the art may make changes to the process described above, all contained within the scope of protection as defined by the following claims.

1. A process for making a braking band for a disc of a disc brake for a motorcycle, the process comprising the steps of:
a) performing a casting by centrifugal casting of a predefined quantity of cast iron, obtaining a tubular semi-finished product;
b) transversely cutting the tubular semi-finished product obtaining a plurality of semi-finished bands having a thickness substantially equal to a thickness of the braking band;
c) cooling the semi-finished band, obtaining a semi-finished band in ductile iron or mainly in spheroidal cast iron;
d) subjecting the semi-finished band to a chip removal process; and
e) making at least one radial hole in radial direction in the braking band to obtain a finished braking band.

2. The process of claim 1, wherein the process comprises,
between step a) and step b),
performing a first tempering heat treatment at a temperature ranging between 400° C. and 500° C., and subsequent cooling, preferably in air.

3. The process of claim 1, wherein the process comprises,
between step b) and step c),
performing a second heat treatment up to a temperature ranging between 700° C. and 800° C.

4. The process of claim 1, wherein the cast iron of step a) is a hypo-eutectic cast iron.

5. The process of claim 4, wherein the hypo-eutectic cast iron has a carbon concentration between 3.5% and 4%.

6. The process of claim 1, wherein by chip removal machining, connection means arc made on the band for connecting to a disc bell are made on the semi-finished band.

7. The process of claim 1, wherein by chip removal machining, axial holes are made on the semi-finished band.

8. A braking band made according to the process of claim 1.

9. The braking band of claim 8, wherein said braking band is in spheroidal cast iron or mainly in spheroidal cast iron.

10. A disc for a disc brake for motorcycles comprising:
a bell for connection to a wheel hub; and
a braking band according to claim 8, provided with connection means;
wherein the braking band is connected to the bell by said connection means.

11. A process for making a braking band for a disc of a disc brake for a motorcycle, the process comprising the steps of:
a) performing a casting by centrifugal casting of a predefined quantity of cast iron, obtaining a tubular semi-finished product;
b) transversely cutting the tubular semi-finished product obtaining a plurality of semi-finished bands having a thickness substantially equal to a thickness of the braking band;
c) cooling the semi-finished band, obtaining a semi-finished band in ductile iron or mainly in spheroidal cast iron; and
d) subjecting the semi-finished band to a chip removal process to obtain a finished braking band.

12. The process of claim 11, wherein the process comprises,
between step a) and step b),
performing a first tempering heat treatment at a temperature ranging between 400° C. and 500° C., and subsequent cooling, preferably in air.

13. The process of claim 11, wherein the process comprises,
between step b) and step c), it is provided to
performing a second heat treatment up to a temperature ranging between 700° C. and 800° C.

14. The process of claim 11, wherein the cast iron of step a) is a hypo-eutectic cast iron.

15. The process of claim 14, wherein the hypo-eutectic cast iron has a carbon concentration ranging between 3.5% and 4%.

16. The process of claim 11, wherein by chip removal machining, connection means for connecting to a disc bell are made on the semi-finished band.

17. The process of claim 11, wherein by chip removal machining, axial holes are made on the semi-finished band.

18. A braking band made according to the process of claim 11.

19. The braking band of claim 18, wherein said braking band is in spheroidal cast iron or mainly in spheroidal cast iron.

20. A disc for a disc brake for motorcycles comprising:
a bell for connection to a wheel hub; and
a braking band according to claim 18, provided with connection means;
wherein the braking band is connected to the bell by said connection means.

21. A disc brake for a motorcycle, comprising:
i) a bell connectable to a wheel hub of the motorcycle;
ii) a braking band according to claim 8 provided with connection means, wherein the braking band is connected to the bell by said connection means; and
iii) a braking caliper comprising friction pads, wherein each friction pad comprises a base surface directed towards a disc of the disc brake, and a layer of friction material that at least partly covers the base surface, wherein the friction material comes into contact with the braking band to brake rotation of the disc, and wherein the friction material comprises organic fibers, the organic fibers being natural rubber and/or carbon.

22. A disc brake for a motorcycle, comprising:
i) a bell connectable to a wheel hub of the motorcycle;
ii) a braking band according to claim 18 provided with connection means, wherein the braking band is connected to the bell by said connection means; and
iii) a braking caliper comprising friction pads, wherein each friction pad comprises a base surface directed towards a disc of the disc brake, and a layer of friction material that at least partly covers the base surface, wherein the friction material comes into contact with the braking band to brake rotation of the disc, and wherein the friction material comprises organic fibers, the organic fibers being natural rubber and/or carbon.
